(19) United States
(12) Patent Application Publication
(10) Pub. No.: US 2021/0365791 A1
(43) Pub. Date: Nov. 25, 2021

(54) RECONFIGURABLE DEVICE BASED DEEP NEURAL NETWORK SYSTEM AND METHOD

(71) Applicant: DEEP AI TECHNOLOGIES LTD., Caesarea (IL)

(72) Inventor: Moshe MISHALI, Zichron Yaakov (IL)

(21) Appl. No.: 17/282,896

(22) PCT Filed: Nov. 26, 2019
(86) PCT No.: PCT/IL2019/051292

§ 371 Date: Apr. 5, 2021

Related U.S. Application Data
(60) Provisional application No. 62/771,608, filed on Nov. 27, 2018.

(51) Int. Cl. G06N 3/08; G06F 15/78; G06N 3/10

(52) U.S. Cl. CPC G06N 3/084; G06N 3/10; G06F 15/7871

(57) ABSTRACT

Provided herein in some embodiments is a deep neural network (DNN) system based on a reconfigurable device such as a field programmable gate arrays (FPGA) configured to use lesser computational resources when training a DNN while maintaining its performance and accuracy levels. Said DNN system may further be used to train a DNN in an increased, rapid pace hence providing real-time operation tailored to the various needs of the user. The reconfigurable device of said DNN system may be dynamically reprogrammed before or during training sessions, or, alternatively, may be programed “on-the-fly” before or during training sessions while adjusting its datapath in response to monitored operational parameters of the DNN system. Such datapath adjustments ensure that multiplications performed during convolution do not include data with under-threshold values, but rather only data with above-threshold value, thereby reducing processing time and computing resources as well as required memory bandwidth.

### FIELD OF THE INVENTION

The present invention relates to deep neural networks (DNN) and, more particularly, but not exclusively, to a convolutional neural network (CNN) system based on a reconfigurable device such as a field programmable gate arrays (FPGA).

### BACKGROUND OF THE INVENTION

In deep learning, Deep Neural Network (DNNs) can perform various applications in various fields and include many types of computational models. One such example is the CNN which is a type of deep, feed-forward artificial neural network frequently used for image and video recognition as well as for natural language processing (NLP) among other applications. Recurrent Neural Networks (RNN) is a class of artificial neural networks where connections between nodes form a directed graph along a temporal sequence, wherein the output of a given layer can feed not only the following layer(s) but also an internal state information, and the input of a given layer can come not only from the previous layer(s) but also from the internal state information. Transformer based Neural networks (TNN) utilize an attention mechanism to find the strength of interaction between its data elements and has weights which can be a function of the semantic relation between data elements, in contrast to, for example, the “distance” between them.

DNN's organization generally resembles that of the nervous system of animals and may be divided into layers, each containing a cluster of neurons, where the output of the cluster of neurons in one layer is passed as an input to a single neuron in another cluster of neurons in a second layer, and the output of the single neuron is then passed together with the output of the neurons in the same cluster in the second layer to a single neuron in a cluster in a third layer and so on until a final output is achieved.

DNNs such as CNNs may include an input layer, hidden convolutional and pooling layers, and an output layer. The input data which is to be processed by the CNN is introduced at the input layer and the resulting output data is generated at the output layer. The convolutional layer generally includes one or more convolutional filters (“kernels”) which, for each filter in the layer, a convolution is performed to generate an inner product from the input data and the filter coefficients. The pooling layer performs a non-linear subsampling of the image to reduce the spatial size of the image and the number of parameters required in the network computations.

Data flow in DNNs such as CNNs is in a forward direction and may pass through multiple convolutional layers and pooling layers, the layers of which may be interleaved. At the output, a loss function, which can consist of the error between labeling of the original input data and the output data, is determined and is propagated backwards through each layer so that the kernels at each layer may be adjusted in order to reduce the error. This process may be iteratively repeated until convergence is obtained, that is, when the error at the output is within a certain threshold. At times, convergence may not be achieved due to overfitting wherein the DNN learned by using a certain bias which is different from the desired task, or due to underfitting wherein the DNN system cannot be trained and reach a convergence.

In DNNs such as CNNs, the previously described convergence process may be computationally intensive and time consuming depending on the task to be performed (e.g. classification, segmentation, recognition, natural language translation, etc.). In order to eliminate the need to program the network every time a task is to be performed, DNNs are generally trained based on the task which they are to carry out. The training typically involves use of training datasets which include data which are used to fit the weights of the various kernels in the network as well as to adjust other network parameters. Although the training may take hours, and sometimes days and weeks, depending on the task to be performed and on the network geometry, once trained the network may be repeatedly used to carry out the task it was trained to perform. It should be noted that the training phase in machine learning, such as DNNs, is separate from the inference phase wherein use of the system enables inferring conclusions and consequences derived from the training phase.

There is a need to provide an efficient system and method that can be used to train DNNs using lesser computational resources while maintaining the DNN's performance and accuracy levels. Such system and method may enable, for example, to run DNN training sessions using various computation platforms. This may be achieved, for example, by using off the shelf configurable devices as part of the DNN system.

There is a further need to provide a system and method capable of training DNNs in an increased, rapid pace. Such system and method may enable, for example, to provide a face recognition or natural language translation with reduced latency, hence providing real-time operation tailored to the various needs of the user.

### SUMMARY OF THE INVENTION

Training DNNs may be computationally intensive and time consuming which may prove costly to a network user. The present invention provides a reconfigurable device based DNN system and a method that may reduce the length of training sessions as well as computational intensiveness while generating an error margin equal to or below an acceptable predetermined threshold.

Said reconfigurable device of said system may be dynamically reprogrammed before or during training sessions, or, alternatively, may be programed “on-the-fly” before or during training sessions while adjusting its datapath in response to monitored operational parameters of the DNN system.

Said system and method may further perform sparse amplification training mode that reprograms the datapath of the reconfigurable device so that multiplications performed during convolution do not include data with under-threshold values, but rather only data with above-threshold value, thereby reducing processing time and computing resources as well as required memory bandwidth.

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other advantages or improvements.

According to one aspect, there is provided a reconfigurable device based deep neural network system, comprising a reconfigurable device, a controller, a library and an HW configuration selector.

According to some embodiments, the HW configuration selector is configured to automatically select HW configurations from the library, the controller is configured to control the running of a training dataset, the system is reconfigured on-the-fly by using the selected HW configurations to modify the datapath of the reconfigurable device, and said reconfiguration is adapted to a use-case to which said system is to be applied.

According to a second aspect, there is provided a reconfigurable device based deep neural network system, comprising a reconfigurable device, a controller and a synthesizer.

According to some embodiments, the controller is configured to control the running of a training dataset, the system is reconfigured on-the-fly by synthesizing new HW configurations and said synthesized new HW configurations are used to modify the datapath of the reconfigurable device and said reconfiguration is adapted to a use-case to which said system is to be applied.

According to some embodiments, the reconfigurable device is a FPGA or CPLD.

According to some embodiments, the system is dynamically reconfigured.

According to some embodiments, the dynamically reconfiguration of said system is driven by the model weight values.

According to some embodiments, a training monitor sources HW configurations from the HW configuration selector in accordance with relation between performance and accuracy.

According to some embodiments, the system further comprising a synthesizer configured to synthesize HW configurations to be stored in the library.

According to some embodiments, the system further comprising a synthesizer configured to synthesize HW configurations that are not found in the library.

According to some embodiments, the deep neural network architecture is configured to be altered by altering the physical configuration of the reconfigurable device.

According to some embodiments, the selected HW configuration is predesigned.

According to some embodiments, wherein the deep neural network is a convolutional neural network.

According to some embodiments, the deep neural network is configured to process imaging data.

According to some embodiments, the deep neural network is configured to process natural language data.

According to some embodiments, the selected HW configuration is a convolution layer, a pooling layer or a fully connected layer.

According to some embodiments, the selected HW configuration is any feed forward layer.

According to some embodiments, the selected HW configuration is any kind of deep neural network arrangement.

According to some embodiments, several HW configurations are combined.

According to a third aspect, there is provided a method for applying sparse training using a reconfigurable device based deep neural network system comprising the steps of generating multiple partial feature maps by applying each filter over a selected data element, repeating the process for each data element until all the feature maps have been completed and conducting unstructured sparse amplification of the kernels with the data elements, such that data elements or kernels with an under-threshold value are not multiplied.

According to some embodiments, the steps are conducted following a selection of a predesigned sparse HW configuration.

According to some embodiments, the steps are conducted following a selection of a sparse HW configuration synthesized on-the-fly.

According to some embodiments, data elements or kernels with a value of zero are not multiplied.

According to some embodiments, a training monitor monitors the neural network unstructured sparse training and in turn initiates the controller to determine the threshold value below it data elements or kernels are not multiplied.

According to some embodiments, the data in the data elements is used to adjust the kernels in the deep neural network system.

According to some embodiments, a controller determines whether to conduct the third step in accordance with the incidence of an under-threshold value in the kernels and/or data elements.

According to a fourth aspect, there is provided a method for applying normal training using a reconfigurable device based deep neural network system, comprising the steps of selecting a dataset in accordance with a predefined user criteria, selecting a HW configuration from a library and perform a training using a reconfigurable device and analyzing the training parameters using a training monitor.

According to some embodiments, training analysis results that indicates a convergence results in an accomplishment of the training session.

According to some embodiments, training analysis results that indicates a lack of convergence triggers sending a request to a HW configuration selector to select HW configuration encoded in a greater or lesser detail.

According to some embodiments, varying levels of detail refers to varying fixed point precision.

According to some embodiments, varying levels of detail refers to varying sparsity threshold.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIG. 1 constitutes a structure diagram illustrating an exemplary reconfigurable device based DNN system, according to some embodiments of the invention.

FIG. 2 constitutes a flowchart diagram illustrating a method of operation leading to two training modes, according to some embodiments of the invention.

FIG. 3 constitutes a flowchart diagram illustrating a normal training mode, according to some embodiment of the invention.

FIG. 4 constitutes a flow chart diagram illustrating the sub operations of operation 314, according to some embodiments of the invention.

FIG. 5 constitutes a flow chart diagram illustrating the sub operations of operation 304, according to some embodiments of the invention.

FIG. 6 constitutes a flow chart diagram illustrating the sub operations of operation 306, according to some embodiments of the invention.

FIG. 7 constitutes a flowchart diagram illustrating a sparse training mode, according to some embodiments of the invention.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform or component that may be provisioned with a Central Processing Unit (CPU) or microprocessors, and may be provisioned with several input/output (I/O) ports, for example, a general-purpose computer such as a personal computer, laptop, tablet, mobile cellular phone, controller chip, SoC or a cloud computing system.

The term “Deep Neural Network” or DNN, as used herein, refers to a computer model that include connectionist systems that are inspired by, but not identical to, biological neural networks that constitute animal brains. A deep neural network can consist of multiple layers. The data elements which are the output of a given layer are typically the input of the following layer (though sometimes the output of given layer can also be used as an input of a deeper layer which is not the following one). A “Deep” neural network is a neural network which has at least one “hidden” layer. A hidden layer is a layer that has two properties: Its input is not the input of the system (but the output of other layer(s)); Its output is not the output of the system (but is used as an input to other layer(s)). The properties of a hidden layer typically mean the designer of the system does not know what the hidden layer represents in the calculation and “blindly trusts” the training process to “imbue something useful” into the layer.

The term “Convolutional Neural Network” or CNN, as used herein, refers to a DNN that has at least some convolutional layers. Each specific neuron in a convolutional layer does not use all the data elements in the input of the layer but only the data elements which are “closer” to it. All the neurons in the convolutional layer use an identical set of weights (cooperatively trained) while a given neuron multiplies a given data element by a weight which is a function of the “distance” between the data element and the neuron.

The term “Reconfigurable device” as used herein, refers to any semiconductor device designed to be reconfigured by a customer or a designer after manufacturing. In contrary to a typical ASIC (Application Specific Integrated Circuit), the reconfigurable device aims at providing the customer or the designer with significant flexibility of its configuration allowing wide diversity of possible logic functions performed in the device. For example, a semiconductor device that comprises some portion that behaves like a typical ASIC and another portion that aims at the above is a reconfigurable device according to the definition used herein.

The term “FPGA” as used herein, refers to a Field-Programmable Gate Array which is a semiconductor device having an integrated circuit and based around a matrix of configurable logic blocks (CLBs) connected via programmable interconnects. An FPGA is designed to be configured by a customer or a designer after manufacturing.

The term “CPLD” as used herein, refers to Complex Programmable Logic Device which is a semiconductor device designed to be configured by a customer or a designer after manufacturing. A CPLD typically offers lower flexibility of its configuration due to its lower amount of logic components compared to a FPGA, but has an advantage of having more deterministic timing and simpler synthesis process.

The term “Kernel” as used herein, refers to a parameterized representation of a surface in the space that can have many forms. Kernels may be used in deep neural network layers to extract features. For example, in a convolutional neural network used for image processing the kernels might represent filters applied on a small region of an image.

The term “Data elements” as used herein, refers to any kind of data or partial data that can be evaluated and processed through DNN. A data element may comprise of data pertaining to an image data element, a voice data element, etc.

The term “Hardware (HW) configuration” as used herein, refers to a series of hardware blocks comprising the network, that may be physically altered or modified in different ways and can be evaluated and processed through DNN. For example, a reconfigurable device such as a FPGA may have various HW configurations.

The term “On-the-fly” as used herein, refers to a single or continuous event along a timeline. For example, a reconfiguration that can be a single or continuous event performed on-the-fly, may be performed at any given time slot before or during a dataset running time, either as a separate event or as a part of a sequence of events, sporadic or continuous.

The term “Loss function” as used herein, refers to a function internally used by a deep learning machine in order to quantify how good its solution is. It is defined so that it has a gradient as a function of each of the learning parameters (Kernel elements). The gradient indicates the direction to which the parameters have to be tuned in order to improve the solution.

Training DNNs may be computationally intensive and time consuming which may prove costly to a network user. In an effort to overcome this problem, the present invention discloses a DNN system based on a reconfigurable device such as a field programmable gate arrays (FPGA), or complex programmable logic device (CPLD) or any other reconfigurable device that may reduce the length of training sessions as well as computational intensiveness while generating an error margin equal to or below an acceptable predetermined threshold.

The present invention further discloses a reconfigurable device such as, but not limited to, a FPGA that may be dynamically reprogrammed before or during training sessions. Alternatively, reconfigurable device may be programed “on-the-fly” before or during training sessions. According to some embodiments, these programming or reprograming procedures adjust the reconfigurable device's datapath in response to monitored operational parameters of the DNN and/or based on predefined user criteria which may include information associated with the network geometry, one or more user selected datasets, cost considerations etc.

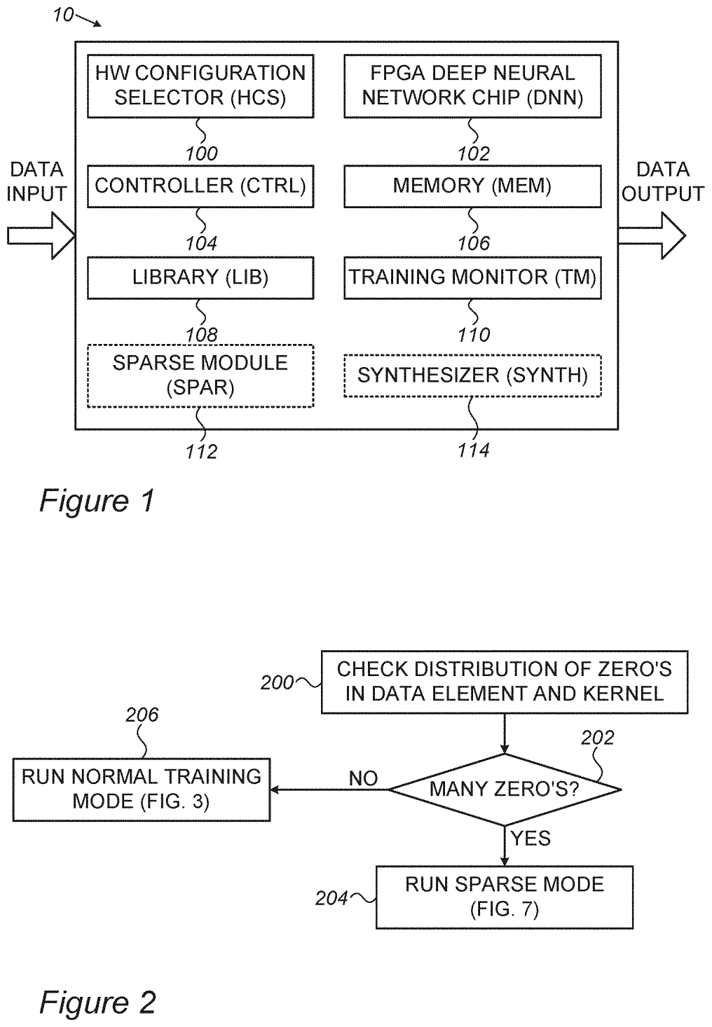

Reference is now made to FIG. 1 which schematically illustrates an exemplary reconfigurable device based DNN system, that can be, according to some embodiments of the invention, a FPGA based DNN system 10. As shown, FPGA DNN system 10 may include a HW Configuration Selector (HCS) 100, an FPGA deep Neural Network chip (FPGA DNN) 102, a Controller (CTLR) 104, a Memory (MEM) 106, a Library (LIB) 108, and a Training Monitor (TM) 110. Optionally, FPGA DNN system 10 may further include a Sparse Module (SPAR) 112 and a Synthesizer (SYNTH) 114.

According to some embodiments, FPGA DNN system 10 may process input data and generate output data which, for example, may be associated with diverse applications. Such applications may include image processing comprising: object detection, object segmentation, motion detection, face recognition, image restoration, scene labelling, image classification, action recognition, human pose estimation, document analysis etc., Natural language processing comprising: speech recognition, natural language translation, question answering, named entity recognition, sentiment analysis, topic recognition, text classification etc., as well as systems and methods for recommendation, customer relationship management, fraud detection, drug discovery etc.

According to some embodiments, FPGA DNN system 10 may further include a dataset comprising data elements such as image data elements, speech data elements etc.

According to some embodiments, reconfiguring of the FPGA DNN system 10 may include automatically selecting predesigned HW configurations that are stored in the system. According to some embodiments, said selected predesigned HW configurations may then be used to modify the datapath of the FPGA DNN system 10.

According to some embodiments, the selected HW configurations may not be predesigned but rather be synthesized “on-the-fly”. In order to achieve this ability, SYNTH 114 that may be included in the FPGA DNN system 10, may be used to automatically synthesize HW configurations which are not predesigned and are not already found in the LIB 108. These synthesized HW configurations may then be optionally added to the LIB 108 to form a part of its regular collection. According to some embodiments, SYNTH 114 may use a similar method used to create the predesign HW configurations.

According to some embodiments, the LIB 108 may store the collection of predesigned HW configurations and/or the selected HW configurations synthesized “on-the-fly”. Optionally, the LIB 108 may include a sparse library which may store a collection of predesigned sparse HW configurations and/or sparse HW configurations synthesized “on-the-fly”, which may be used during sparse amplification (disclosed hereinafter). These sparse HW configurations may be used to modify (reprogram) the datapath of the FPGAs so that multiplications performed during convolution do not include data with under-threshold values, for example, a zero value, but rather only data with above-threshold value, for example, a non-zero value.

According to some embodiments, The HCS 100 may select predesigned or synthesized “on-the-fly” HW configurations from the LIB 108 which may be used to adjust the size and weights of the network kernels.

The HCS 100 may select the HW configurations upon a request from the TM 110 and based on the TM's 110 monitoring of the operational parameters of the FPGA DNN system 10. According to some embodiments, in the HW configuration selection procedure, the HCS 100 may take into consideration the predefined user criteria.

According to some embodiments, the TM 110 may monitor the operational parameters of the FPGA DNN system 10 and may take into account, in its request for an HW configuration from the HCS 100, tradeoffs between network speed and network accuracy, in other words, the TM 110 may take into account the relations between the performance and precision of FPGA DNN system 10's operation.

For example, if the TM 110 determines that the network is stable using 16 bit FP encoding but that the speed of the network may be increased without making the network unstable and/or where the error at the output of one or more layers, or at the output layer, exceeds a predetermined, maximum acceptable error threshold, the TM 110 may request from the HCS 100 to select a HW configuration with lower precision encoding (for example, fixed point precision encoding), for example, 8 bit FP encoding. If the 8 bit FP encoding causes instability or a large error, the TM 110 may request from the HCS 100 to select a HW configuration encoded using a precision (for example, fixed point precision encoding) between 8 bit FP and 16 bit FP, for example 12 bit FP.

According to some embodiments, The FPGA DNN system 10 may be an FPGA CNN (convolution neural network) system 10, and FPGA DNN 102 may be FPGA CNN 102 chip that may include a convolutional neural network architecture while its geometry may be defined based on the predefined user criteria and in accordance to changing needs and various conditions.

According to some embodiments, associated with the FPGA DNN system 10 is the MEM 106 which may be used to store the dataset information for each FPGA DNN chip 102. The MEM 106 may comprise a DDR memory, or any other types of a suitable memory components.

According to some embodiments, the operation of the FPGA DNN system 10 may be controlled by the CTRL 104 which may dynamically adjust the datapath of the FPGA DNN chip 102 during training sessions according to the coding parameters of the data cell selected by the HCS 100. According to some embodiments, the CTRL 104 may control the operation of the FPGA DNN system 10 in two different modes of training, “normal training mode” and “sparse training mode”.

Reference is now made to FIG. 2 which constitutes a flowchart diagram illustrating a method of operation leading to two training modes, according to some embodiments of the invention. As shown, operation 200 may include using the CTRL 104 to check the distribution of zero and non-zero values in the kernels and optionally in the data elements selected.

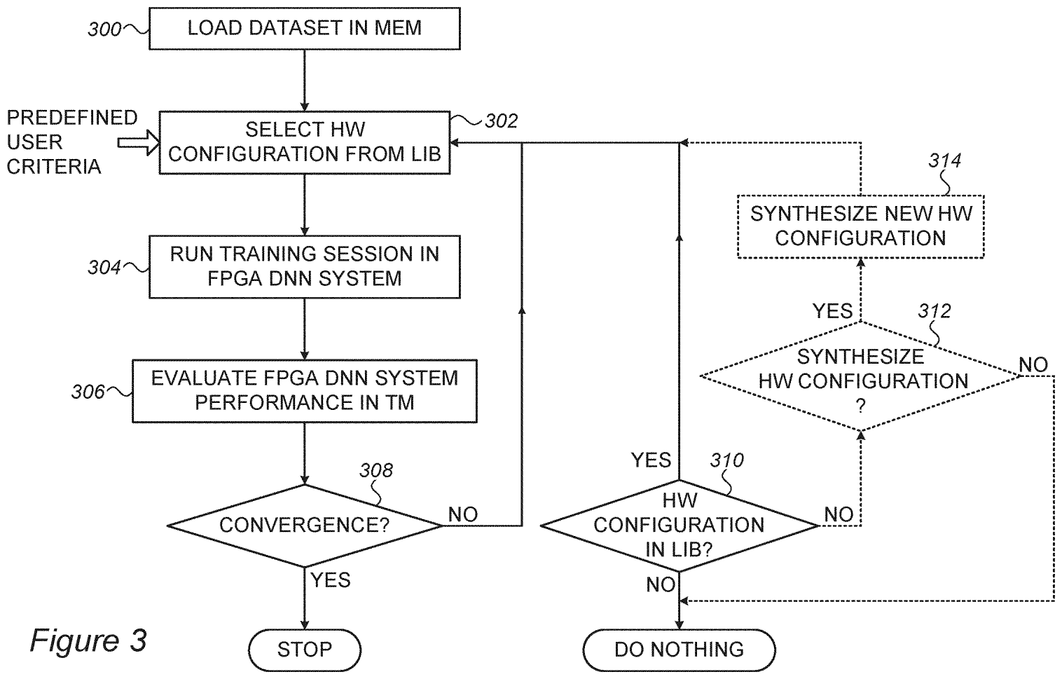

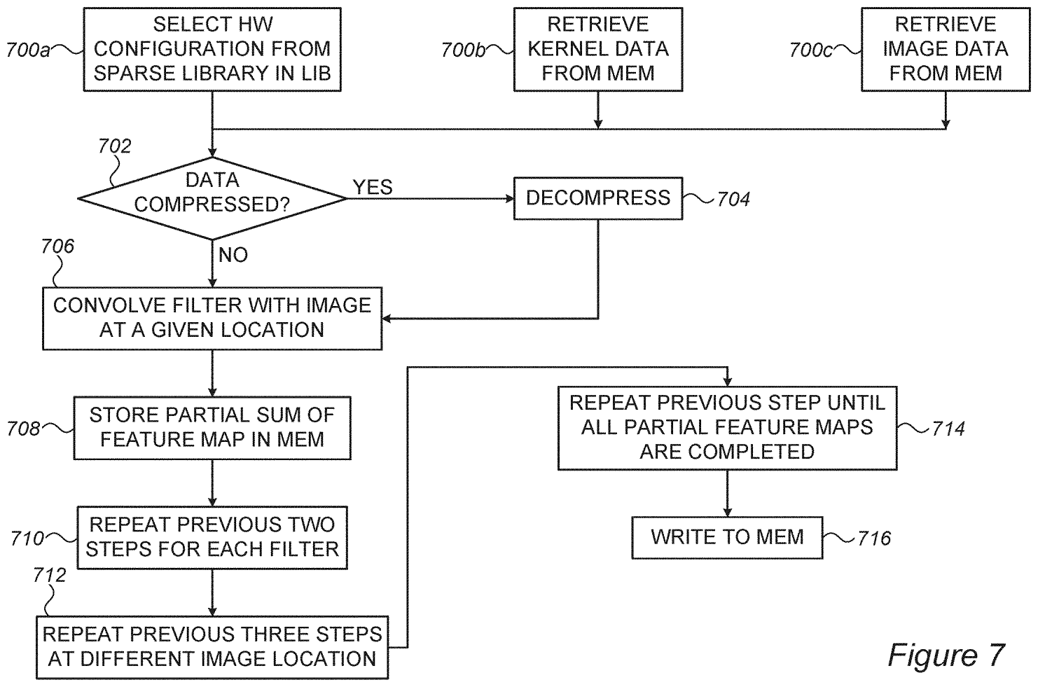

Operation 202 may include determining if the number of zero's values in the kernels and/or the selected data elements are equal to or exceeds a predetermined threshold, if the number of said zero's values exceeded said predetermined threshold, operation 204 may include using the CTRL 104 to select running the sparse mode of training. If the number of zero's values did not exceed said predetermined value, operation 206 may include using the CTRL 104 to select running the normal mode of training (said two modes of training are described in greater detail in FIGS. 3 and 7, respectively).

Reference is now made to FIG. 3 which is an exemplary flow chart of the normal training mode, according to some embodiments of the invention. For clarity purposes the normal training mode is described herein with reference to a FPGA CNN system which is often used to process imaging data, whereas the present invention may apply to any reconfigurable DNN system. The skilled person may appreciate that the exemplary flow chart shown is for illustrative purpose and that the normal training mode executed by said FPGA CNN system may be practiced using more or less operations and/or a different sequence of operations.

As shown, in operation 300, the dataset selected by the user that can be, for example, a part of a predefined user criteria, may be downloaded to the MEM 106 where it may be accessed by the FPGA CNN chip 102. According to some embodiments, only a portion of the dataset may be downloaded to the MEM 106 or alternatively, the whole dataset may be downloaded. Each FPGA CNN chip 102 in the FPGA CNN system 10 may access all the dataset stored in the MEM 106 or may, alternatively, be limited to accessing only specific predetermined areas of the dataset.

In operation 302, the HCS 100 may select a predesigned or synthesized “on-the-fly” HW configuration, (such as a HW configuration configured for image processing) from the LIB 108. According to some embodiments, in a first training run, the HCS 100 may select the HW configuration based on the predetermined user criteria.

In operation 304, the CTLR 104 may program the FPGA CNN 102 in the FPGA CNN system 10 based on the parameters of the selected HW configuration. A first training run may then be executed through the FPGA CNN system 10. The operational parameters of the network may be monitored by the TM 110 in real-time, or alternatively may be monitored following the training run as part of the next operation.

In operation 306 the TM 110 may evaluate the monitored operational parameters of the network and may determine whether or not another training run should be performed. The TM 110 may perform a tradeoff analysis to determine the relations between network speed and network accuracy taking into account, among other factors, the user requirements in order to attempt achieving an optimum balance between performance and accuracy.

In operation 308, the TM 110 may evaluate if the network has converged and if the optimum speed and accuracy have been achieved in accordance with the user requirements and possibly other factors. If yes, then the network has been optimally trained and the training session may be stopped. If not, the TM 110 may send a request to the HCS 100 to select a HW configuration which may be encoded with a greater or lesser precision depending on the results of the TM's 110 evaluation of the monitored operational parameters.

For example, and according to some embodiments, the TM 110 may send a request to the HCS 100 to select a 16 bit FP encoded HW configuration configured for image processing if the first training run was based on an 8 bit FP encoded HW configuration and the monitored operating parameters (i.e. the network performance) did not meet the network requirements. In another example, the TM 110 may send a request to the HCS 100 to select a 16 bit FP encoded HW configuration configured for image processing if the first training run was based on a 32 bit FP encoded HW configuration and the monitored operating parameters (i.e. the network performance) have exceeded network requirements.

According to some embodiments, if the network did not reach convergence, operation 308 of the normal training mode may use the HCS 100 to repeat operation 302, or alternatively, move forward to operation 310 that may use the HCS 100 to check the LIB 108 to see if there is a stored HW configuration which may conform to the TM's 110 request. If yes, the HCS 100 may select said HW configuration, taking into consideration, among other factors, the predefined user criteria, and may initiate an iterative process which may take the network a number of times through operation 302 to 306 until convergence is achieved. If there is no stored HW configuration in the LIB 108, the FPGA CNN system 10 may either do nothing or, alternately consider synthesizing an HW configuration as part of operation 312 further disclosed below.

In operation 312, the system may evaluate whether to synthesize a HW configuration. According to some embodiments, synthesizing an HW configuration may be done if an HW configuration which does not appear in the LIB 108 is frequently requested during training sessions. According to some embodiments, if an HW configuration is seldom requested, it may be preferable to not synthesize the HW configuration and to do nothing.

In operation 314, the HW configuration may be synthesized resulting in a new HW configuration which may be optionally stored in the LIB 108 for repeated use, such as, repeating operation 302 to select HW configuration from LIB 108 and so on until reaching convergence.

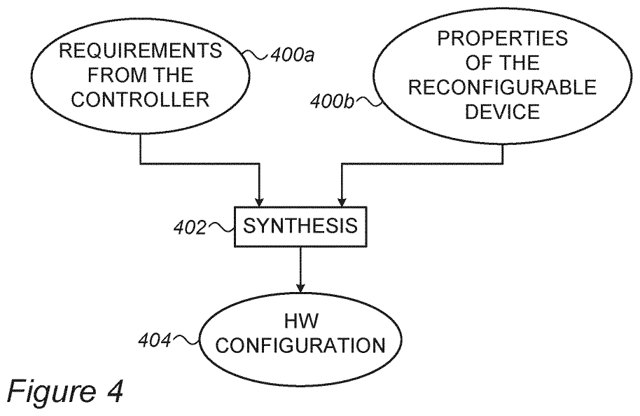

Reference is now made to FIG. 4 which constitutes a flow chart diagram illustrating the sub operations of operation 314, according to some embodiments of the invention. As shown, in operation 400a the requirements for a desired HW configuration are sent from the CTRL 104, in operation 400b the properties of a desired HW configuration are gathered. As said, a desired HW configuration may be an HW configuration that is frequently requested during training sessions. According to some embodiments, operations 400a and 400b may be executed simultaneously or at a different time frame from each other.

In operation 402 a synthesis of a new HW configuration is performed using the SYNTH 114, resulting in operation 404 that may optionally store the new HW configuration in the LIB 108 for repeated use.

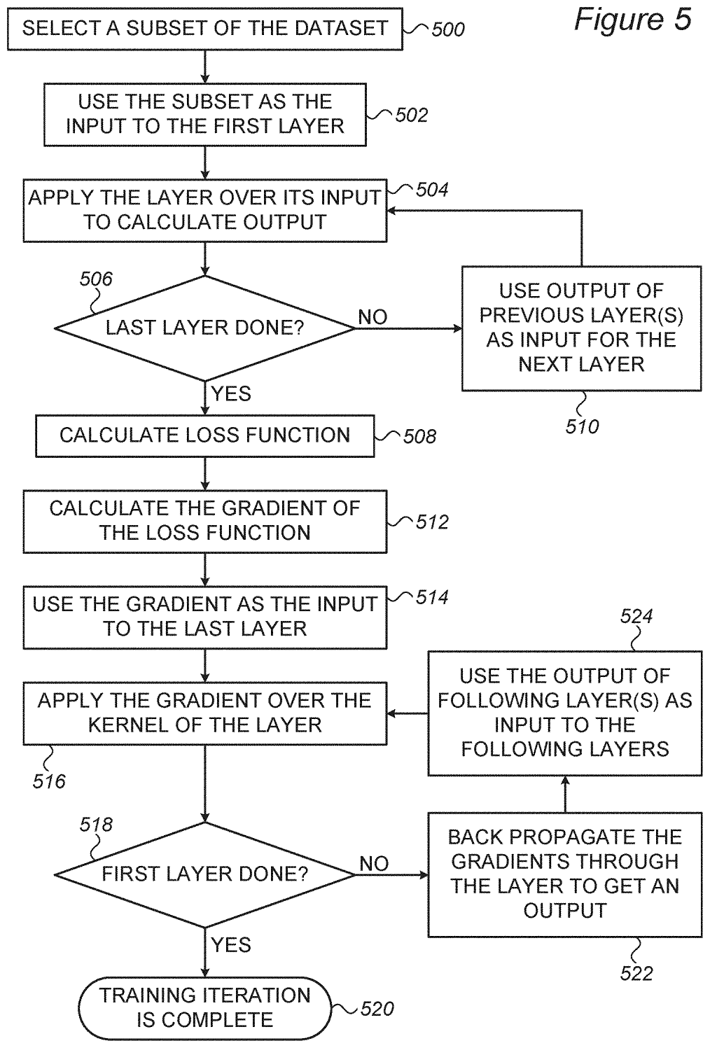

Reference is now made to FIG. 5 which constitutes a flow chart diagram illustrating the sub operations of operation 304, according to some embodiments of the invention. As shown, in operation 500, FPGA CNN system 10 selects a subset of the dataset. in operation 502, the chosen subset is used as the input to the first layer of the FPGA CNN 102. in operation 504 the layer is applied over its input to calculate the output and so on until reaching the last layer. In operation 506, FPGA CNN system 10 checks if the last layer has undergone the aforementioned operations, if yes, a loss function is calculated as part of operation 508, if no, operation 510 is applied. In operation 510, FPGA CNN system 10 uses the output of the previous layer(s) as an input for the next layer and then repeats operation 504 and so on.

In operation 512 FPGA CNN system 10 calculates the gradient of the loss function. In operation 514, FPGA CNN 102 uses the gradient as the input to the last layer. In operation 516, FPGA CNN system 10 applies the gradient over the kernel of the layer. In operation 518, FPGA CNN system 10 checks if the first layer has undergone the aforementioned operations successively, if yes, the training iteration is complete as part of operation 520, if no, FPGA CNN system 10 back propagates the gradients through the layer to set an output as part of operation 522.

In operation 524, FPGA CNN system 10 uses the output of the following layer(s) as an input to yet to come following layers and in turn repeats operation 516 and so on.

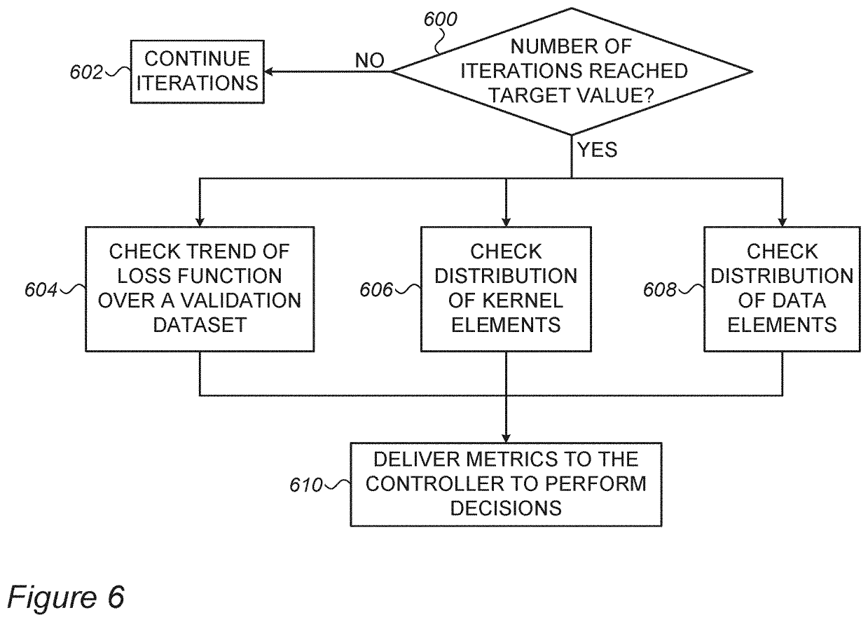

Reference is now made to FIG. 6 which constitutes a flow chart diagram illustrating the sub operations of operation 306, according to some embodiments of the invention. As shown, in operation 600 FPGA CNN system 10 checks the number of iterations have reached target value. If the target value has not been achieved, FPGA CNN system 10 continues to perform iteration until reaching target value as part of operation 602, if target value is achieved, FPGA CNN system 10 checks the trend of loss function over a validation dataset as part of operation 604. FPGA CNN system 10 may also check the distribution of kernel elements in the layer(s) as part of operation 606. FPGA CNN system 10 may also check the distribution of data elements through the system as part of operation 608. According to some embodiments, operations 604, 606 and 608 may be executed simultaneously or at a different time frame from each other. In operation 610, FPGA CNN system 10 delivers metrics to the CTRL 104 to perform decisions.

Reference is now made to FIG. 7 which is an exemplary flow chart of the sparse training mode, according to some embodiments of the invention. For clarity purposes the sparse training mode is described herein with reference to a FPGA CNN system which is mainly used to process imaging data whereas the present invention may apply to any reconfigurable DNN system. The skilled person may appreciate that the exemplary flow chart shown is for illustrative purpose and that the sparse training mode executed by said FPGA CNN system may be practiced using more or less operations and/or a different sequence of operations.

According to some embodiments, sparse amplification may sometimes be used in training a FPGA CNN, in particular when there are many under-threshold values, for example, zero values in the selected data element and/or the kernel. According to some embodiments, as part of said sparse amplification, a tradeoff may be made between memory bandwidth and processing time by first generating multiple partial feature maps by convolving each filter with the selected data element on a same location on the data element, and successively repeating the process for each data element until all the feature maps have been completed.

According to some embodiments, when multiplying a kernel with a data element as part of conducting sparse amplification, data with a value under a certain threshold, for example, a zero, in either the kernel or the data element is not multiplied, that is, only data with value over a certain threshold, for example, non-zero, in both the data element and the kernel are multiplied, thereby reducing processing time and computing resources. Additional processing time may be gained by not accessing from MEM 106 to retrieve kernel data and/or data of a selected data element with a value under a certain threshold, for example, a zero.

According to some embodiments, using said method of sparse amplification, in exchange for gaining processing time, memory bandwidth is sacrificed as partial sums for each convolved location on the selected data element requires storing in MEM 106 (for each partial feature map).

According to some embodiments, addresses which contain data values under a certain threshold, for example, a zero, are not accessed to reduce processing time. This may be implemented, for example, by having the kernel decoder transmit to the CTRL 104 the location of values under a certain threshold, for example, a zero, so as to reduce the need to access the corresponding locations on the image (and inversely by having the image data element decoder transmit to the CTRL 104 the location of values under a certain threshold, for example, a zero).

As shown, in operation 700a, following determination that the sparsity ratio (number of multiplications of data with values under a certain threshold, for example, a zero, out of a total number of multiplications of data having zero and non-zero values between the kernel data and the image data) is equal to or greater than a predetermined threshold, the HCS 100 may select a predesigned sparse HW configuration that optimally fits the sparsity ratio encountered, from the sparse library in LIB 108. According to some embodiments, operation 700b may be executed by the CTRL 104 accessing and retrieving the kernel data from the MEM 106. According to some embodiments, operation 700c may be executed by the CTRL 104 accessing and retrieving the image data element the MEM 106.

According to some embodiments, operations 700a 700b and 700c may be executed simultaneously or at a different time frame from each other. According to some embodiments, HCS 100 may select an HW configuration that is synthesized “on-the-fly” such that it optimally fits the sparsity ratio encountered, from the sparse library in LIB 108.

In operation 702, a determination may be made if the data in the HW configuration and/or the kernel is encoded. In a case the data is encoded, it is decoded as part of operation 704, prior to proceeding to the next operation. In a case the data is not encoded, the process may proceed to the next operation.

In operation 706, a partial feature map may be generated for a given location on the image by multiplying (convolving) the kernels having values over a certain threshold, for example non-zero, with corresponding image data element having values over a certain threshold, for example, non-zero, at the same location. If a kernel value is under a certain threshold, for example, a zero, and/or an image data element value is under a certain threshold, for example, a zero, these are not multiplied together as their multiplication will yield an under a certain threshold value or a zero. According to some embodiments, not multiplying said kernel and/or image data element with one another may reduce processing time and save computing resources.

In operation 708, the data calculated in operation 706 for the partial feature map may be stored in MEM 106.

In operation 710, operations 706 and 708 may be repeated for each filter (kernel) to generate a plurality of partial feature maps for the same image location. The data calculated for each partial feature map may be stored in MEM 106.

In operation 712, operation 706, 708 and 710 may be repeated for another location on the image data element.

In operation 714, operation 712 may be repeated until all locations in the image data element have been convolved.

In operation 716, upon completion of a feature map, the data may be written into the MEM 106 for further processing by the FPGA CNN system 10.

According to some embodiments, during both normal and sparse training modes, the data in the data elements may be used to adjust the kernels in the FPGA CNN system 10 and may include a collection of samples of encoded data of varying sizes and precision. According to some embodiments, associated with each encoded data sample are compressed weight parameters which may then be used to adjust the kernels (kernel size and weights) during training.

For example, and according to some embodiments, HW configurations configured for image processing may include 32 bit floating point compressed weights for performing a 3×3 convolution on a 500 pixel size image data elements. A second HW configurations configured for image processing may include 32 bit floating point compressed weights for performing a 5×5 convolution on a 2000 pixel size image data elements. A third HW configurations configured for image processing may include 16 bit floating point compressed weights for performing a 3×3 convolution on a 5000 pixel size image data elements. A fourth HW configurations configured for image processing may include 16 bit floating point compressed weights for performing a 1×1 convolution on a 4000 pixel size image data elements. A fifth HW configurations configured for image processing may include 16 bit floating point compressed weights for performing a 1×1 convolution on a 400 pixel size image and may additionally include 32 bit floating point compressed weights for performing a 3×3 convolution on a 1000 pixel size image data elements, and so on.

According to some embodiments, the information associated with the geometry of the FPGA CNN 102 may include the number of layers, the types of layers, the number of filters, the depth of the filters, the number of feature maps, convoluting parameters such as padding and/or strides, among other various network geometry information.

According to some embodiments, the dataset information may be obtained from existing dataset sources. Examples of such dataset sources may include, for image classification, CIFAR10, CIFAR100, and ImageNet, among other datasets known in the art.

According to some embodiments, the monitored operational parameters of FPGA CNN 102 may include operational parameters such as, for example, error measured on each layer output in last/recent operations, distribution of parameters per layer, distribution of parameters derivative (over time) per layer, distribution of parameters variance (over some time) per layer, convergence rate in last/recent operations, as measured by various loss functions at the end of the neural network, amount of fixed-point overflow and underflow encountered per layer in last/recent operations, current epoch (i.e. how many sweeps of the entire dataset have passed through the system), amount of objects per class in dataset, error measurement per class, and error measurement on class-pairs that passed together through the neural network.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. A reconfigurable device based deep neural network training acceleration system, comprising:
(i) a reconfigurable device;
(ii) a controller;
(iii) a library;
(iv) an HW configuration selector,
wherein the HW configuration selector is configured to automatically select HW configurations from the library,
wherein the controller is configured to control the running of a training dataset,
wherein the system is reconfigured on-the-fly by using the selected HW configurations to modify the datapath of the reconfigurable device, and
wherein said reconfiguration is adapted to a use-case to which said system is to be applied.

2-4. (canceled)

5. The system of claim 1 wherein the system is dynamically reconfigured.

6. The system of claim 5, wherein the dynamically reconfiguration of said system is driven by the model weight values.

7. The system of claim 1, wherein a training monitor sources HW configurations from the HW configuration selector in accordance with relation between performance and accuracy.

8. The system of claim 1, wherein the system further comprising a synthesizer configured to synthesize HW configurations to be stored in the library.

9. The system of claim 1, wherein the system further comprising a synthesizer configured to synthesize HW configurations that are not found in the library.

10. The system of claim 1, wherein the deep neural network architecture is configured to be altered by altering the physical configuration of the reconfigurable device.

11. The system of claim 1, wherein the selected HW configuration is predesigned.

12. The system of claim 1, wherein the deep neural network is a convolutional neural network.

13-14. (canceled)

15. The system of claim 1, wherein the selected HW configuration is a convolution layer.

16. The system of claim 1, wherein the selected HW configuration is a pooling layer.

17. The system of claim 1, wherein the selected HW configuration is a fully connected layer.

18. The system of claim 1, wherein the selected HW configuration is any feed forward layer.

19. The system of claim 1, wherein the selected HW configuration is any kind of deep neural network arrangement.

20. The system of claim 1, wherein several HW configurations are combined.

21. A method for applying sparse training acceleration using a reconfigurable device based deep neural network system, comprising the steps of:
(i) generating multiple partial feature maps by applying each filter over a selected data element,
(ii) repeating the process for each data element until all the feature maps have been completed,
(iii) conducting unstructured sparse amplification of the kernels with the data elements, such that data elements or kernels with an under-threshold value are not multiplied.

22. The method of claim 21, wherein the steps are conducted following a selection of a predesigned sparse HW configuration.

23. The method of claim 21, wherein the steps are conducted following a selection of a sparse HW configuration synthesized on-the-fly.

24. The method of claim 21, wherein data elements or kernels with a value of zero are not multiplied.

25. The method of claim 21, wherein a training monitor monitors the neural network unstructured sparse training and in turn initiates the controller to determine the threshold value below it data elements or kernels are not multiplied.

26. The method of claim 21, wherein the data in the data elements is used to adjust the kernels in the deep neural network system.

27. The method of claim 21, wherein a controller determines whether to conduct step (iii) in accordance with the incidence of an under-threshold value in the kernels and/or data elements.

28. A method for applying normal training acceleration using a reconfigurable device based deep neural network system, comprising the steps of:
(i) selecting a dataset in accordance with a predefined user criteria,
(ii) selecting a HW configuration from a library and perform a training using a reconfigurable device,
(iii) analyzing the training parameters using a training monitor.

29. The method of claim 28, wherein the system is dynamically reconfigured.

30. The method of claim 29, wherein the dynamically reconfiguration is driven by the model weight values.

31. The method of claim 28, wherein a training monitor sources HW configurations from the HW configuration selector in accordance with relation between performance and accuracy.

32. The method of claim 28, wherein the selected HW configuration is predesigned.

33. The method of claim 28, wherein the selected HW configuration is synthesized on-the-fly.

34. (canceled)

35. The method of claim 21, wherein the deep neural network is a convolutional neural network.

36. The method of claim 21, wherein the deep neural network is configured to process imaging data.

37. The method of claim 21, wherein the deep neural network is configured to process natural language data.

38. The method of claim 28, wherein training analysis results that indicates a convergence results in an accomplishment of the training session.

39. The method of claim 28, wherein training analysis results that indicates a lack of convergence triggers sending a request to a HW configuration selector to select HW configuration encoded in a greater or lesser detail.

40. The method in claim 39 wherein varying levels of detail refer to varying fixed point precision.

41. The method in claim 39 wherein varying levels of detail refer to varying sparsity threshold.

42-43. (canceled)

44. The system of claim 1, wherein the system is capable of synthesize new HW configurations in order to provide on-the-fly reconfiguration to the system, wherein said synthesized new HW configurations are used to modify the datapath of the reconfigurable device, and wherein said reconfiguration is adapted to a use-case to which said system is to be applied.
